(19) United States
(12) Patent Application Publication
(10) Pub. No.: US 2004/0071883 A1
(43) Pub. Date: Apr. 15, 2004

(54) Method and apparatus for coating thin film

(75) Inventors: Tomonari Ogawa, Shizuoka (JP); Kazuhiko Nojo, Shizuoka (JP); Tsutomu Kurokoshi, Shizuoka (JP)

Correspondence Address: SUGHRUE MION, PLLC, 2100 Pennsylvania Avenue, NW, Washington, DC, 20037-3213, US

(73) Assignees: FUJI PHOTO FILM CO., LTD.; TOMOEGAWA PAPER CO., LTD.

(21) Appl. No.: 10/447,267

(22) Filed: May 29, 2003

(30) Foreign Application Priority Data
May 29, 2002 (JP) P.2002-156048

(51) Int. Cl. B05D 3/04

(52) U.S. Cl. 427/378; 118/200; 118/100

(57) ABSTRACT

A method and apparatus for coating a thin film which comprises supplying an organic solvent-based coating solution onto the surface of a transferring member from which the coating solution is then allowed to come in contact with a film base so that it is applied thereto while the coating solution which has been supplied onto the transferring member is being partially recovered for reuse.

### BACKGROUND OF THE INVENTION

The present invention relates to a method and apparatus for coating a thin film using an organic solvent-based coating solution and more particularly to a technique for uniformizing the spread of coating solution.

Examples of methods for applying a coating solution to a film include various coating methods such as gravure coating method, roll coating method and bar coating method. In particular, the gravure coating method comprises, by way of example, supplying a coating solution 2 onto the surface of a gravure roll 1 which is being rotationally driven, scraping excess coating solution off the surface of the gravure roll 1 with a doctor blade 3 pressed against the surface of the gravure roll 1, and then applying the coating solution in the cell of the gravure roll 1 to a film base 4 as shown in FIG. 15. The doctor blade 3 is pressed against the surface of the gravure roll 1 during the period between the supply of the coating solution 2 from a coating solution reservoir 5 onto the surface of the gravure roll 1 and the contact of the coating solution 2 with the film base 4. In FIG. 15, the reference numerals 6a to 6c each indicate a guide roll, and the reference numeral 8 indicates a drying zone. The film base 4 runs in the direction represented by the arrow Y1, and the gravure roll 1 rotates in the direction represented by the arrow Y2.

It is known in this type of a method for continuous coating of an organic solvent-based coating solution onto a film base that the relative humidity in the ambient atmosphere is predetermined to not lower than 50 to 60% to prevent electrostatic charge developed by the passage of the film base through a number of conveyance rolls to the coating zone, thereby securing safety.

However, some solvents for coating solution have a high hygroscopicity. It is further known that since when the coating solution spread over the gravure roll is returned as excess portion to the coating solution reservoir, it is repeatedly allowed to come in contact with the ambient air, some coating solutions absorb water content in the ambient air to increase its viscosity or undergo modification. Since there has been rarely reported that malcoating occurs or the finished product has quality problem for this reason, this type of problems have been given no detailed study.

The inventors conducted reverse gravure coating with an acrylic resin coating solution comprising MEK (methyl ethyl ketone or the like as a solvent using an apparatus having a configuration shown in FIG. 15. As a result, it is found that although there are no special problems in the initial stage of coating, streaks are often generated on the coat with time, causing the change of spread of coating solution. Whenever such a coating trouble occurred, the coater portion (periphery of the gravure roll) is cleaned. However, little or no improvements are made.

On the other hand, it is found that when the coating solution is renewed, the coating state can be returned to the original uniform state. When the water content in the coating solution at this point is measured, it is found that the water content increases with the elapse of time during coating. It is known from these experimental results that though depending on the kind of coating solution used, when the water content is beyond 1%, it is mostly usual that there appears a sign of physical change such as increase of viscosity of the coating solution that causes the occurrence of streaks on the coat or the change of spread of coating solution.

### SUMMARY OF THE INVENTION

The invention is worked out on the basis of the aforementioned knowledge. An aim of the invention is to provide a method and apparatus for coating a thin film which comprises supplying an organic solvent-based coating solution onto the surface of a transferring member while the coating solution is being partially recovered for reuse wherein the coating solution is prevented from absorbing water content in the air to stabilize the coating state of the coating solution and uniformize the spread of coating solution.

In order to accomplish the aim of the invention, the method for coating a thin film according to the invention defined in Aspect 1 lies in a method for coating a thin film which comprises supplying an organic solvent-based coating solution onto the surface of a transferring member from which the coating solution is then allowed to come in contact with a film base so that it is applied thereto while the coating solution which has been supplied onto the transferring member is being partially recovered for reuse, wherein the vapor-liquid interface is covered by an air inflow preventive cover on the area except the area of contact of the transferring member with the film base while the contact area is exposed at the opening, the edge of the opening of the air inflow preventive cover extends to a position in the vicinity of the film base at least on the film base conveyance side and the coating zone of the transferring member is disposed in a isolated space formed by partitioning from the open air.

In accordance with this method for coating a thin film, the vapor-liquid interface is covered by an air inflow preventive cover on the area except the area of contact of the transferring member with the film, causing the vapor-liquid interface which doesn't need to be exposed to the open air to be isolated from the open air and hence forming an isolated space between the air inflow preventive cover and the surface of the transferring member. In this arrangement, the inflow of the open air directly into the isolated space can be prevented. Further, the evaporation of the solvent for the coating solution in the vicinity of the vapor-liquid interface such as surface of the transferring member can be inhibited, preventing the drop of the temperature of the coating solution and hence the dew condensation of water content in the air. Moreover, by extending the edge of the opening of the air inflow preventive cover to a position in the vicinity of the film base, the introduction of a surface air layer entrained by the film base which is being conveyed into the isolated space during the conveyance of the film base can be prevented. This effect of preventing the inflow of open air and the dew condensation of water content can prevent the water content from being taken in the coating solution. As a result, the occurrence of defects such as streak in the spread state of the coating solution on the film base can be prevented, making it possible to stabilize the application of the coating solution to the film base and uniformize the amount of the coating solution spread on the entire surface of the film base.

The method for coating a thin film as defined in Aspect 2 comprises supplying an inert gas into the interior of the aforementioned isolated space.

In accordance with this method for coating a thin film, an inert gas is supplied into a space defined by the air inflow preventive cover, making it possible to provide the vapor-liquid interface with an inert gas atmosphere and hence prevent the inflow of open air. Thus, the water content in the open air can be prevented from being taken in the coating solution.

The method for coating a thin film as defined in Aspect 3 comprises sucking and removing a surface air layer entrained by the film base which is being conveyed on the film base conveyance side.

In accordance with this method for coating a thin film, the surface air layer entrained by the film base which is being conveyed is directly sucked and removed, making more sure that the introduction of open air into the isolated space is prevented.

The apparatus for coating a thin film as defined in Aspect 4 supplies an organic solvent-based coating solution onto the surface of a transferring member from which the coating solution is then allowed to come in contact with a film base so that it is applied thereto while the coating solution which has been supplied onto the transferring member is being partially recovered for reuse, wherein there is provided an air inflow preventive cover having an opening at which the area of contact of the transferring member with the film base is exposed and covering the vapor-liquid interface on the area except the contact area, the edge of the opening extending to a position in the vicinity of the film base.

In operation of the apparatus for coating a thin film, the vapor-liquid interface is covered by an air inflow preventive cover on the area except the area of contact of the transferring member with the film, causing the vapor-liquid interface which doesn't need to be exposed to the open air to be isolated from the open air and hence forming an isolated space between the air inflow preventive cover and the surface of the transferring member. In this arrangement, the inflow of the open air directly into the isolated space can be prevented. Further, the evaporation of the solvent for the coating solution in the vicinity of the vapor-liquid interface such as surface of the transferring member can be inhibited, preventing the drop of the temperature of the coating solution and hence the dew condensation of water content in the air. Moreover, by extending the edge of the opening of the air inflow preventive cover to a position in the vicinity of the film base, the introduction of a surface air layer entrained by the film base which is being conveyed into the isolated space during the conveyance of the film base can be prevented. This effect of preventing the inflow of open air and the dew condensation of water content can prevent the water content from being taken in the coating solution. As a result, the occurrence of defects such as streak in the spread state of the coating solution on the film base can be prevented, making it possible to stabilize the application of the coating solution to the film base and uniformize the amount of the coating solution spread on the entire surface of the film base.

In the apparatus for coating a thin film as defined in Aspect 5, the air inflow preventive cover has a wall portion extending along the external surface of the transferring member and the opening formed at the forward end of the external wall portion.

In accordance with this apparatus for coating a thin film, there is provided a wall portion extending along the external surface of the transferring member, making it possible to improve the airtightness of the air inflow preventive cover from the open air and hence inhibit the inflow of the open air into the isolated space in the air inflow preventive cover.

The apparatus for coating a thin film as defined in Aspect 6 is arranged such that the area of the clearance between the air inflow preventive cover and the surface of the transferring member is not greater than 0.4 m²/m per unit length thereof and the clearance between the edge of the air inflow preventive cover and the film base is not greater than 10 mm.

In accordance with this apparatus for coating a thin film, the area of the clearance between the air inflow preventive cover and the surface of the transferring member is kept to not greater than 0.4 m²/m, making it possible to prevent the change of the properties of the coating solution. Further, the clearance between the edge of the air inflow preventive cover and the film base is kept to not greater than 10 mm, making it sure that a surface air layer entrained by the film base which is being conveyed can be removed.

The apparatus for coating a thin film as defined in Aspect 7 comprises an inert gas supplying portion for supplying an inert gas into the interior of the isolated space.

In accordance with this apparatus for coating a thin film, an inert gas is introduced from the inert gas supplying portion into a space defined by the air inflow preventive cover, making it possible to provide the vapor-liquid interface of the transferring member with an inert gas atmosphere and hence prevent the inflow of the open air. Thus, the water content in the open air can be prevented from being taken in the coating solution.

The apparatus for coating a thin film as defined in Aspect 8 comprises a suction duct for sucking a surface air layer entrained by the film base which is being conveyed on the film base conveyance side.

In accordance with this apparatus for coating a thin film, a surface air layer entrained by the film base which is being conveyed can be sucked and removed, making more sure that the introduction of the open air into the isolated space is prevented.

The background of the aforementioned invention will be described hereinafter. In general, when a vapor-liquid interface exists, a solvent evaporates, causing the latent heat to be lost and hence lowering the liquid temperature. As a result, the air in the vicinity of the vapor-liquid interface comes in contact with the liquid having a low temperature to undergo dew condensation, causing the water content in the air to be taken in the solvent. This phenomenon has a great effect on the surface conditions when the spread of coating solution is as small as not greater than 10 cc/m². It may he proposed that the relative humidity of the air be lowered extremely to prevent this phenomenon. However, when the humidity in the coating chamber is too low, static electricity can be easily generated to cause sparking during the running of the film base, making it likely that the solvent can be flamed.

On the other hand, it may be proposed that an inert gas be blown against the vapor-liquid interface to replace the air in the vicinity thereof by the inert gas. However, this approach requires that a large amount of an inert gas be supplied into the coating zone, making it difficult to secure working safety.

Under these circumstances, extensive studies have been made of effective method for coating a thin film which can prevent the coating solution fed to the coating solution supplying portion from causing the dew condensation of water content in the ambient air or taking the water content therein. As a result, it is found important to eliminate the evaporation of the solvent contained in the coating solution and hence inhibit the drop of the temperature of the coating solution in order to prevent the dew condensation of water content in the air at the aforementioned coating solution supplying portion. To this end, it is essential to inhibit the drop of the concentration of solvent gas in the vicinity of the vapor-liquid interface. Thus, the coating solution supplying portion is required to have such an arrangement that the vaporized gas can be difficultly diffused.

In other words, it is required that a cover be provided in the vicinity of the vapor-liquid interface to render the vapor-liquid interface fully airtight or, even if not fully airtight, make it difficult for the vapor to diffuse. The coating solution supplying portion at which a continuous sheet is continuously coated has a great vapor-liquid interface. The coating solution which has been supplied onto the surface of the transferring member is then returned to the original position except the portion which has been spread over the film base for reuse. Thus, even at one batch of feed, water in the air undergoes dew condensation, though in a short period of time. The water is then taken in the coating solution.

In particular, among the coating solution which has been supplied onto the surface of the transferring member, the returned portion repeatedly has a vapor-liquid interface. Consequently, the returned portion has a great evaporating area (vapor-liquid interface), extending the time during which water content in the air can undergo dew condensation.

It is then found that when the path of the returned solution is covered almost airtightly, there occurs no evaporation and odor development of solvent and the amount of water content to be taken in the returned solution can be reduced. The returned solution forms a vapor-liquid interface on the surface of the transferring member and in the returned solution recovery path and thus comes in contact with air. Thus, the zone of the vapor-liquid interface is covered by a metal impermeable to solvent gas or like material. In the conventional configuration, the film base is disposed above the transferring member during coating. Thus, the vapor-liquid interface above the gravure roll is kept covered considerably. However, the portion for supplying the coating solution onto the surface of the transferring member is shaped considerably open for work such as cleaning. Therefore, when there turned solution flows, much solvent evaporates. Further, since the solvent gas in the vicinity of the vapor-liquid interface moves with the movement of the solution, the concentration of the solvent evaporated decreases, giving an atmosphere in which the solvent gas can easily evaporate, Moreover, since the film base continuously runs, high humidity air entrained by the film base which is being conveyed is supplied onto the aforementioned vapor-liquid interface, causing the vapor-liquid interface to be continuously exposed to air.

In the invention, the coating solution supplying zone is covered by a cover at the area where the evaporated solvent gas diffuses and the distance between the opening of the cover and the film base is predetermined to not greater than 10 mm, preferably not greater than 5 mm, making it possible to inhibit the inflow of the surface air layer entrained by the film base which is being conveyed into the coating solution supplying zone. Further, the area of the gap between the cover and the surface of the gravure roll where the evaporated gas can diffuse to the exterior of the cover is predetermined to not greater than 0.4 m²/m to inhibit the evaporation of the solvent from the solution supplying zone and hence the drop of temperature of the solution, making it possible to reduce the amount of water content to be condensed. In this arrangement, the absorption of water content by the coating solution can be reduced to an extent such that the coating solution can be continuously used over an extended period of time.

It has heretofore been known that a cover similar to that described above is used to prevent the evaporation of solvent. However, it has not been specifically defined to what extent the solution supplying zone should be closed such a cover is provided only for the countermeasure against the problems of evaporation loss of solvent or problems with the working atmosphere due to odor development of solvent evaporated. On the other hand, the limitation of the water absorption, which is an aim of the invention, has a definite dependence on the area of evaporation and diffusion of solvent or the evaporated amount of solvent. It is known that when the evaporation loss of solvent is not smaller than 0.5%/kg/hr, the coating solution changes in its properties and thus causes various troubles. It is also known that the aforementioned evaporation loss can easily occur when the diffusion area of solvent gas (i.e., vapor-liquid interface in the coating solution supplying zone) is not smaller than a predetermined value. Though depending on the shape of the cover or conditions such as supply of inert gas, the diffusion area is preferably predetermined to not greater than 1.5 m²/m, more preferably not greater than 0.5 m²/m.

The invention is characterized in that an air inflow preventive cover is provided to isolate the coating solution from the open air in order to satisfy these requirements.

### BREIF DESCRIPTION OF THE DRAWINGS

FIG. 1 is a diagram illustrating the essential part of a gravure coating device of the reverse gravure coating type in which the gravure roll is rotated in the direction opposite the conveyance direction of the film base;

FIG. 2 is a conceptional diagram illustrating a part of an air inflow preventive cover covering a gravure roll;

FIG. 3 is a diagram illustrating how the film base is conveyed;

FIG. 4 is a diagram illustrating an enlargement of the portion in the vicinity of the air inflow preventive cover 65 on the film base entrance side;

FIG. 5 is a diagram illustrating a first modification of the air inflow preventive cover;

FIG. 6 is a diagram illustrating a second modification of the air inflow preventive cover;

FIG. 7 is a partial diagram illustrating a suction duct and a blowing duct provided together;

FIG. 8 is a partial diagram illustrating an embodiment of the plates having the forward end which forms an acute angle;

FIGS. 9A and 9B are diagrams illustrating a gravure coating method according to the invention, FIG. 9A is a perspective view exaggeratedly illustrating bend and FIG. 9B is a diagram of FIG. 9A as viewed in the direction indicated by the arrow Ib;

FIG. 10 is a diagram illustrating how to determine the bend of gravure roll during gravure coating;

FIG. 11 is a diagram illustrating the conditions for use in the calculation of the bend of gravure roll;

FIG. 12 is a diagram illustrating the essential part of a gravure coating apparatus of direct gravure coating type according to the second embodiment of implementation of the invention;

FIG. 13 is a diagram illustrating the essential part of a gravure coating apparatus of roll coating type according to the third embodiment of implementation of the invention;

FIG. 14 is a diagram illustrating the essential part of a bar coating apparatus of direct gravure coating type according to the fourth embodiment of implementation of the invention; and

FIG. 15 is a diagram illustrating a related art gravure coating method and apparatus.

### DETAILED DESCRIPTION OF THE PREFERRED EMBODIMENTS

Preferred embodiments of the method and apparatus for coating a thin film of the invention will be described hereinafter in connection with the attached drawings.

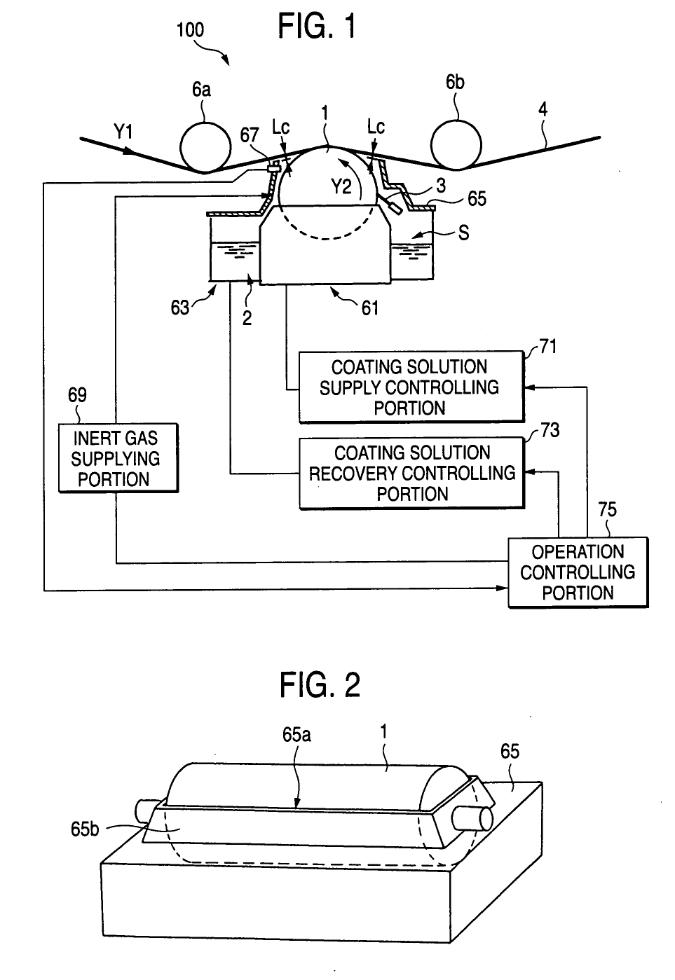

Firstly, an embodiment of the application of the method for coating a thin film of the invention to gravure coating method will be described hereinafter. FIG. 1 is a diagram illustrating the essential part of a gravure coating device of the reverse gravure coating type in which the gravure roll is rotated in the direction opposite the conveyance direction of the film base. FIG. 2 is a conceptional diagram illustrating a part of an air inflow preventive cover covering a gravure roll.

A gravure coating apparatus 100 of the present embodiment is arranged such that a coating solution is supplied to the surface of a gravure roll (transferring member) 1 which is being rotationally driven while excess coating solution on the surface of the gravure roll 1 is being scraped off with a doctor blade 3 pressed against the surface of the gravure roll 1, and the coating solution attached to a cell formed on the surface of the gravure roll 1 is then spread over a film base 4.

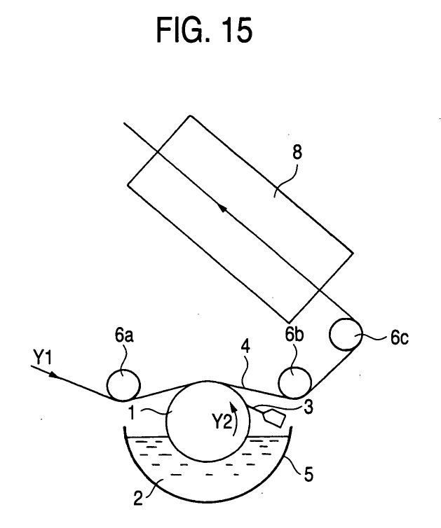

The basic configuration of the gravure coating apparatus 100 is similar to that of the gravure coating apparatus shown in FIG. 15 but is different from that of the gravure coating apparatus shown in FIG. 15 in that there is provided a cover covering the periphery of the gravure roll and the coating solution is recycled. In other words, the present gravure coating apparatus 100 comprises a coating solution supplying portion 61 for supplying an organic solvent-based coating solution onto the surface of a gravure roll 1 rotatably born on bearings, a doctor blade 3 which is pressed against the surface of the gravure roll 1 to scrape off excess portion of the coating solution thus supplied, a coating solution recovering portion 63 for recovering the excess coating solution, etc. scraped off by the doctor blade 3, and an air inflow preventive cover 65 provided covering the gravure roll 1 on the area except the area of contact with the film base 4 for inhibiting the evaporation of the coating solution. The present gravure coating apparatus 100 further comprises a sensor 67 provided in an isolated space S isolated from the open air by the air inflow preventive cover 65 above the coating solution recovering portion 63 for detecting any of the concentration of nitrogen, relative humidity, evaporation of coating solution, etc. in the space S and an inert gas supplying portion 69 for supplying an inert gas such as argon gas and nitrogen gas into the isolated space S.

The gravure coating apparatus 100 further comprises a coating solution supply controlling portion 71 for controlling the coating solution supplying operation of the coating solution supplying portion 61, a coating solution recovery controlling portion 73 for controlling the coating solution recovering operation of the coating solution recovering portion 63, and an operation controlling portion 75 for giving an operation instruction to the coating solution supply controlling portion 71, the coating solution recovery controlling portion 73 and the inert gas supplying portion 69 upon the reception of output signal from the sensor 67.

The air inflow preventive cover 65 is provided extending all over the axial length of the gravure roll 1 and comprises an opening 65a provided opposed to the area of the gravure roll 1 with the film base 4 as shown in FIG. 2. The air inflow preventive cover 65 further comprises a wall portion 65b extending to the position in the vicinity of the film base to cover the vapor-liquid interface on the surface of the gravure roll 1 except the area of contact with the film base 4. In this arrangement, the air inflow preventive cover 65 substantially covers the vapor-liquid interface on the surface of the gravure roll 1 except the area of contact with the film base 4 and the vapor-liquid interface on the coating solution recovering portion 63 except in that the area of contact with the film base 4 is exposed. Accordingly, the region except the area of the gravure roll 1 in contact with the film base 4, the region in the coating solution recovering portion 63 where the returned solution is stored and the region where the coating solution is exposed are isolated from the open air by the air inflow preventive cover 65. In this arrangement, the isolated space S is formed between the air inflow preventive cover 65 and the surface of the gravure roll. By predetermining the clearance Lc between the opening 65a of the air inflow preventive cover 65 and the surface of the film base 4 to not greater than 10 mm, preferably not greater than 5 mm, the inflow of open air entrained by the film base 4 which is being conveyed into the isolated space S defined by the air inflow preventive cover 65 is prevented.

The term “isolated space S” as used herein is meant to indicate both the space between the exposed surface of the returned solution in the coating solution recovering portion 63 inside the air inflow preventive cover 65 and the outer surface of the gravure roll 1 and the space defined substantially by the film base 4 in the vicinity of the area of contact with the gravure roll 1, the edge of the opening 65a of the air inflow preventive cover and the air inflow preventive cover 65.

The area of the clearance between the opening 65a of the air inflow preventive cover 65 and the surface of the gravure roll 1 is predetermined to not greater than 0.4 m²/m per unit axial length of the gravure roll 1. In this arrangement, the sealing effect of the isolated space S defined by the air inflow preventive cover 65 can be enhanced to prevent the evaporation of the coating solution in the isolated space S and hence the dew condensation of water content in the air due to the drop of temperature of the coating solution caused by the absorption of latent heat accompanying the evaporation. The aforementioned effect can keep the temperature of the coating solution higher than the temperature of ambient air and the relative humidity in the space to not higher than 30%, making it possible to inhibit the dew condensation of water content in the air to an extent such that the coating solution can be continuously used over an extended period of time.

Inside the isolated space S defined by the air inflow preventive cover 65 is provided the sensor 67 so that any of the detected value of nitrogen concentration, relative humidity, evaporation of coating solution, etc. is inputted to the operation controlling portion 75 which then controls the inert gas supplying portion 69 to adjust the rate of inflow of an inert gas into the space. When the inert gas supplying portion 69 supplies an inert gas into the isolated space S, the pressure in the isolated space S is then raised to a value of not lower than that of the open air (atmospheric pressure) by not 0.1 Pa or less. The operation controlling portion 75 outputs control signal to the coating solution supply controlling portion 71 for controlling the amount of coating solution to be supplied into the coating solution supplying portion 61 and to the coating solution recovery controlling portion 73 for controlling the withdrawal of the coating solution to be recovered by the coating solution recovering portion 63 to supply the coating solution onto the gravure roll 1 under desired operating conditions.

The coating solution which has been recovered from the aforementioned coating solution recovering portion 63 is then recycled again to the coating solution supplying portion 61 by the coating solution recovery controlling portion 73.

In order to supply an inert gas into the isolated space S defined by the air inflow preventive cover 65, the inert gas supplying portion 69 doesn't blow an inert gas against the vapor-liquid interface on the surface of the gravure roll 1, in the coating solution recovering portion 63 or the like but merely allows an inert gas to flow into the isolated space S. This supplying system is intended to keep the clearance between the opening 65a of the air inflow preventive cover 65 and the gravure roll 1 small, thereby enhancing the airtightness of the isolated space S. In other words, even when an inert gas is not blown against the vapor-liquid interface on the gravure roll 1, the isolated space S can be thoroughly filled with an inert gas merely by allowing an inert gas to flow into the isolated space S.

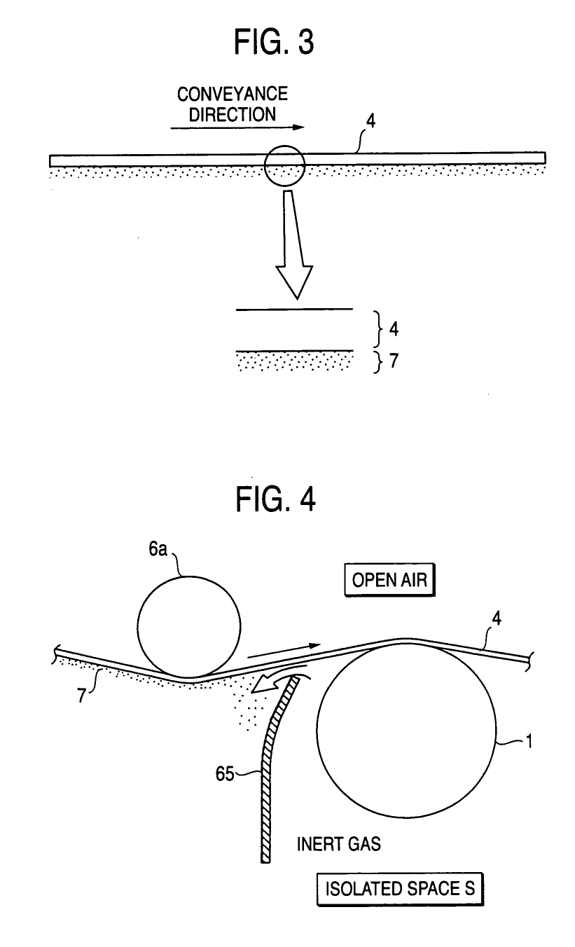

The significance of the supply of an inert gas in the invention will be described in detail hereinafter. As shown in FIG. 3, which illustrates how the film base is conveyed, the film base 4 which is being conveyed has a surface air layer 7 called “entrained air” present on an extremely thin surface region thereof which moves with the conveyance of the film base 4. This surface air layer 7 has a relatively high relative humidity developed at the previous step. Therefore, when the film base 4 is conveyed into the isolated space S with the surface air layer 7 entrained thereby, the water content in the surface air layer 7 is then absorbed by the vapor-liquid interface in the isolated space S, causing the change of the properties of the coating solution. Accordingly, it is necessary that the surface air layer be destroyed to prevent the inflow of the surface air layer 7 into the isolated space S before the conveyance of the film base 4 into the isolated space S.

To this end, the present embodiment is arranged such that the wall portion 65b of the air inflow preventive cover 65 is provided close enough to the film base 4 to scrape off the surface air layer 7. FIG. 4 illustrates an enlargement of the portion in the vicinity of the air inflow preventive cover 65 on the film base entrance side. As shown in FIG. 4, since the pressure of the inert gas in the isolated space S is as slightly as not lower than 0.1 Pa higher than the open air, the presence of the air inflow preventive cover 65 causes the occurrence of a flow of an inert gas from the isolated space S to the open air, blowing off the surface air layer 7 on the film base 4 which is being conveyed. Accordingly, only the film base 4 free of surface air layer 7 is conveyed into the isolated space S inside the air inflow preventive cover 65. In this manner, the inflow of the surface air layer 7 containing much water content can be prevented, making it possible to prevent the rise of relative humidity in the isolated space S.

Modifications of the present embodiment of the air inflow preventive cover 65 will be sequentially described hereinafter.

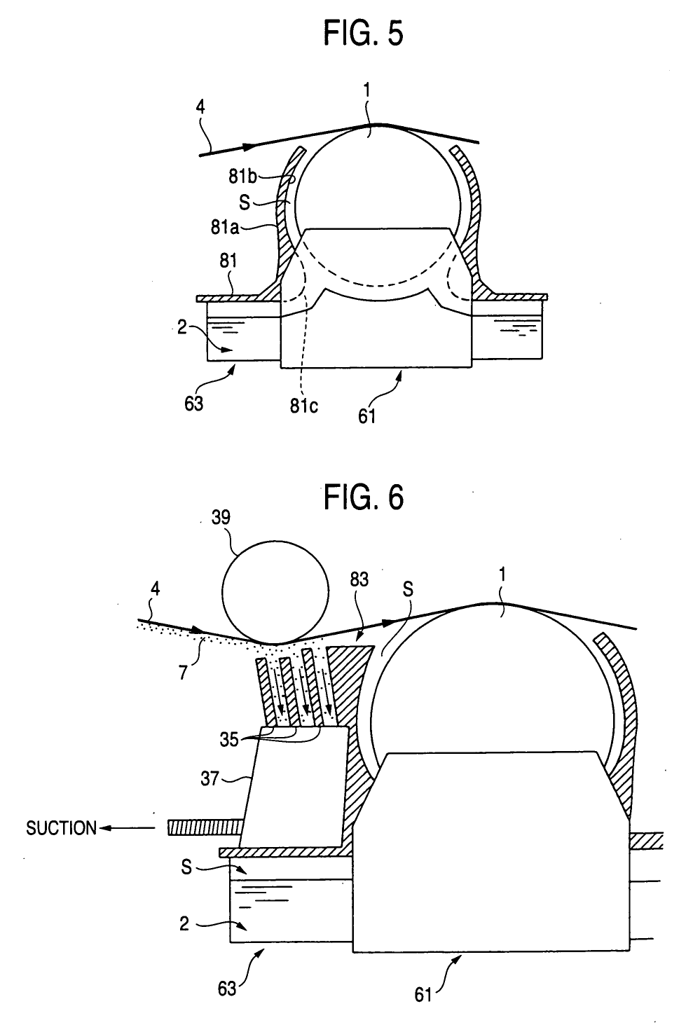

FIG. 5 is a diagram illustrating a first modification of the air inflow preventive cover. In this modification, an air inflow preventive cover 81 has a wall portion 81a extending along the outer surface of a columnar gravure roll 1. The wall portion 81a has an inner surface 81b having a curved surface corresponding to the outer surface of the gravure roll 1 provided opposed to the outer surface of the gravure roll 1 at a substantially constant distance. At the excess coating solution recovery zone, the lower inner surface 81c of the wall portion is shaped smoothly curved according to the outer surface of the gravure roll 1 so that the excess coating solution attached to the gravure roll 1 smoothly flows down to the coating solution recovery portion 63 where it is then recovered.

In accordance with this modification, the wall portion 81a of the air inflow preventive cover 65 is disposed opposed to the gravure roll 1 at a large area with a reduced clearance to inhibit the flow of gas through the clearance, enhancing the airtightness of the isolated space by the air inflow preventive cover 65. Accordingly, the entrance of open air into the isolated space S and the diffusion of the coating solution steam to the exterior can be inhibited. The air inflow preventive cover 65 may not be necessarily formed integrally as shown in FIG. 5 but may be formed by a plurality of parts in combination.

Another modification of the present embodiment of the air inflow preventive cover 65 will be described hereinafter.

FIG. 6 is a diagram illustrating a second modification of the air inflow preventive cover. In this modification, an air inflow preventive cover 83 has a plurality (three steps shown) of plates 35 disposed in parallel along the axial direction of the gravure roll 1 at a regular interval on the film base entrance side. The clearance between the plates 35 is communicated to a suction duct 37 communicated to a suction apparatus 37 such as vacuum pump (not shown). Provided on the side of the film base 4 opposite the plates 35 is a roll 39 for preventing the vibration of the film base 4 due to suction. The various plates 35 are oriented in a direction crossing the running direction of the film base 4 at an angle of not greater than 90° so that suction is made possible in the forward direction with the conveying direction of the film base 4.

In accordance with the aforementioned constitution of the air inflow preventive cover 83, the surface air layer 7 on the film base 4 is sucked by the suction duct 37 through the clearance between the plates 35, causing the surface air layer 7 to be removed from the surface of the film base 4 by the beginning of entrance of the film base 4 into the isolated space S. In this manner, it can be made more sure that the inflow of the surface air layer 7 containing much water content into the isolated space S is prevented. The degree of this suction effect can be adjusted by changing the number of the plates 35 or properly adjusting the suction power of the suction apparatus. In order to prevent the suction of the film base 4, the suction pressure is preferably adjusted to not greater than 100 Pa. The velocity of air to be sucked to the plates 35 is preferably predetermined to not lower than the conveyance speed of the film base 4.

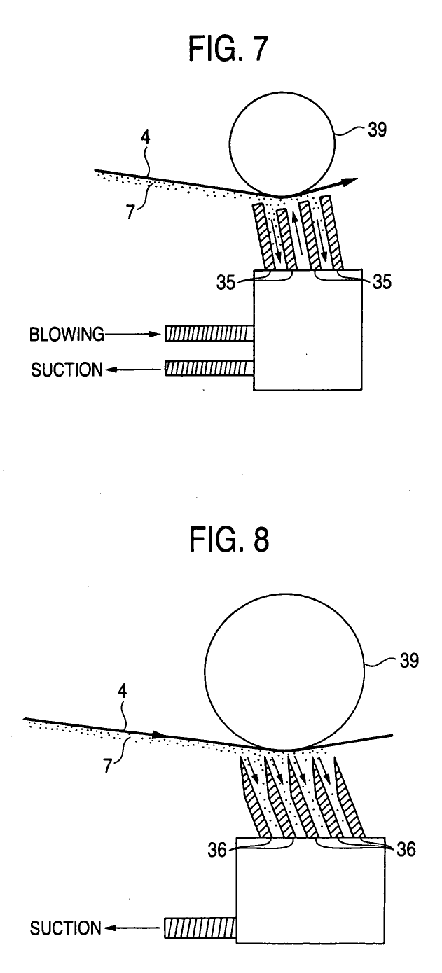

By communicating any of the clearances between the plates 35 to a blowing duct as partly shown in FIG. 7 so that a suction duct and a blowing duct are present together, the efficiency of removal of the surface air layer 7 from the film base 4 can be enhanced. In other words, by conducting blowing and suction on the film base 4 at the same time, the surface air layer is scattered by blowing and then sucked at once, enhancing the effect of removing the surface air layer. By predetermining the direction of blowing against the film base 4 opposite the conveyance direction of the film base 4, it can be made more sure that the entrance of the surface air layer 7 into the isolated space S is prevented. The blowing pressure in this procedure is preferably predetermined to not lower than the suction pressure. The gas to be blown is low humidity air, preferably inert gas taking into account the possibility of flow of a part thereof to the rear part of conveyance path.

The plates 35 in the aforementioned various modifications have their forward end positioned at an equal distance (e.g., not greater than 5 mm) from the surface of the roll 39 so as to follow the radius of curvature of the roll 39. Referring to the shape of the forward end of the plates, the forward end of the plates may form an acute angle as partly shown in FIG. 8.

The doctor blade 3 of the present gravure coating apparatus 100 will be described in detail hereinafter.

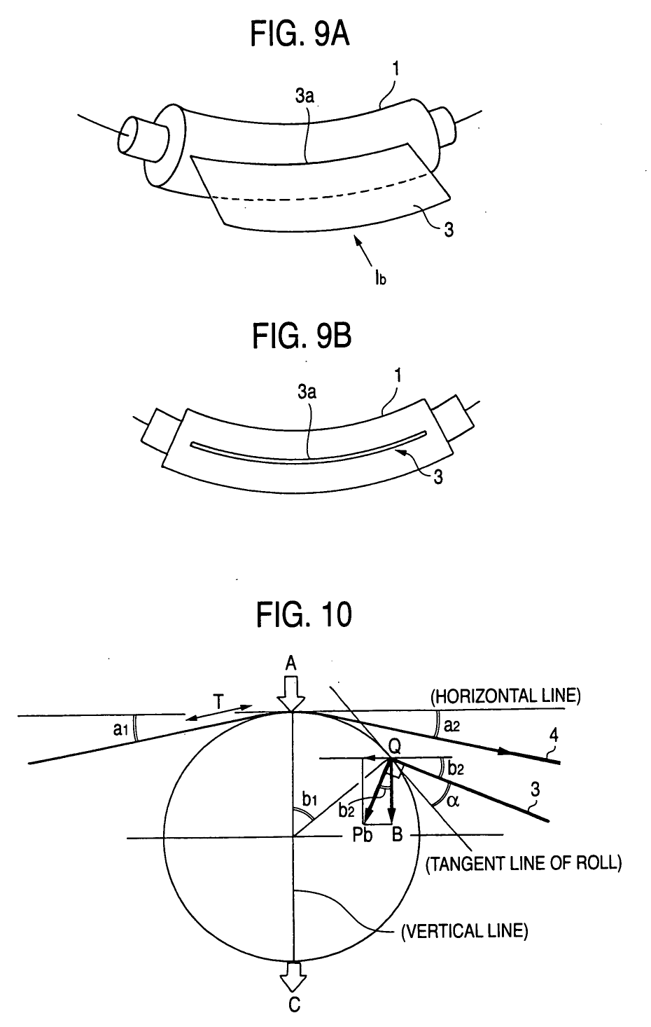

FIGS. 9A and 9B are diagrams illustrating the relationship between the gravure roll and the doctor blade. FIG. 9A is a perspective view. FIG. 9B is a diagram of FIG. 9A as viewed in the direction indicated by the arrow 1b.

The doctor blade 3 is bent substantially as much as the gravure roll 1 is bent in the direction perpendicular to the axial direction as exaggeratedly shown in FIGS. 9A and 9B to scrape off excess coating solution.

The doctor blade 3 is also bent in such an arrangement that at least the forward contact end 3a thereof comes in sure contact with the gravure roll 1 on the surface thereof, particularly on the same generant of the gravure roll (axial line of the surface of the unbent roll). The direction indicated by the arrow 1b in FIG. 9D is perpendicular to the direction (substantially crosswise direction) of maximum bend (substantially longitudinal direction) of the gravure roll 1.

How to determine the bend of the gravure roll 1 will be described hereinafter in connection with FIG. 10. Examples of the force that deflects the gravure roll 1 include the vertical component of tension T of the film base 4 which comes in contact with the gravure roll 1, the vertical component of pressure Pb of the doctor blade 3 against the gravure roll 1, and the weight of the gravure roll 1. The doctor blade 3 is pressed against the surface of the gravure roll 1 at an angle of b₂ from the horizontal line at the point Q which is positioned at an angle of b₁ from the vertical line extending through the center of the gravure roll 1. These factors are predetermined such that the following conditions are satisfied.

(a) Weight of gravure roll>pressure of doctor blade

(b) 0°<b₁<90°

(c) −45°<b₂<45°

(d) a₁≦30°, a₂≦30°

In other words, in accordance with the condition (a), the pressure of the doctor blade is predetermined smaller than the weight of the gravure roll so that the horizontal component of the pressure of the doctor blade is sufficiently small. In accordance with the condition (b), the angle b₁ can be predetermined such that the horizontal force of the doctor blade is not too great and the scraping properties of the doctor blade are good. In accordance with the condition (c), the horizontal component of the pressure of the doctor blade can be predetermined smaller than the vertical component of the pressure of the doctor blade. In accordance with the condition (d), the horizontal component of the tension of the film base can be predetermined small. Accordingly, when the aforementioned conditions (a) to (d) are satisfied, the horizontal force acting on the gravure roll is sufficiently small with respect to the vertical force, making it possible to determine the bend of the gravure roll with no practical problems even taking into account the vertical force alone.

When the film base satisfies the relationship a₁>a₂, the horizontal component of the tension of the film occurs in the direction opposite that of the horizontal component of the pressure of the doctor blade, causing the two horizontal forces to be substantially cancelled each other. Even when any nonnegligible horizontal force occurs, a blade having a curved contact end as described in JP-A-6-55124 can be used to press against the gravure roll uniformly over the axial length thereof, making it possible to give a uniform distribution of spread of coating solution.

Let us now pay attention to the vertical force alone supposing that the maximum bend of the gravure roll 1 occurs in the direction perpendicular to the axial direction thereof and the horizontal bend of the gravure roll 1 is negligibly small. The weight of the gravure roll 1 acts downward vertically and thus is referred as “force C”. The vertical force A which is acted on the gravure roll 1 by the tension T of the film base 4 is represented by the following equation (1).

A=T sin a₁+T sin ga₂ (2)

wherein a₁ is the angle between the film base 4 on the incoming side and the horizontal line; and a₂ is the angle between the film base 4 on the outgoing side and the horizontal line. The horizontal component B of the pressure P_{B} of the doctor blade 3 against the gravure roll 1 is represented by the following equation (2).

B=P_{B} cos b₂ (2)

The resultant of these forces A, B and C acts vertically. Thus, supposing that the vertical force P is represented by the following equation:

P=A+B+C (3)

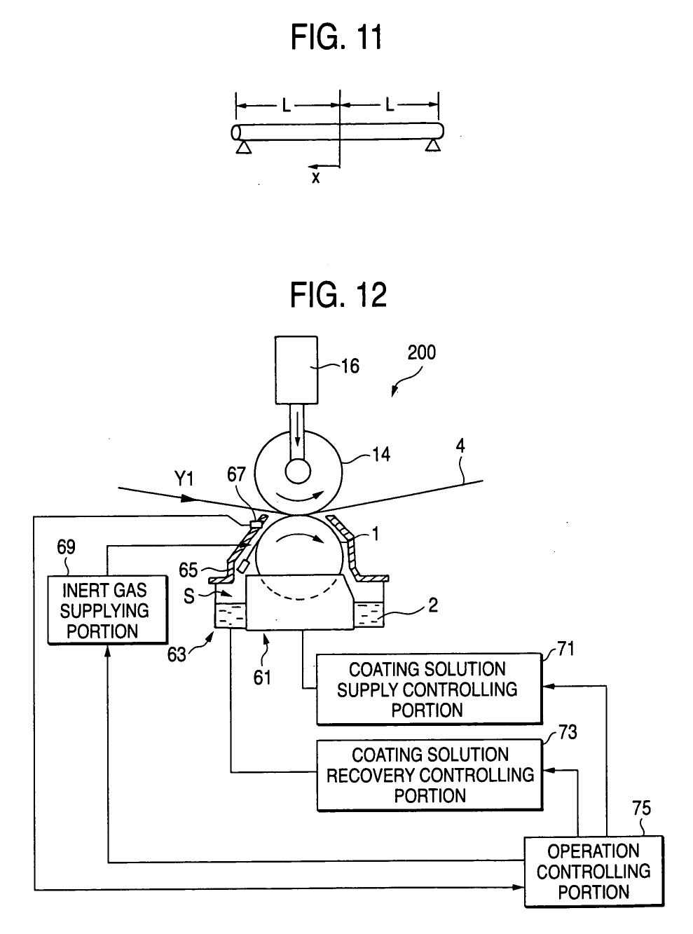

, the bend of the gravure roll 1 in the vertical direction, i.e., direction perpendicular to the axial line is determined as bend by equal load on the both bearings shown in FIG. 11 by the following equation (4):

Bend={L⁴P/(2EI)}[1/2·{(L-x)/L}²−1/12·{(L-x)/L}⁴] (4)

where

P: Force that deflects gravure roll (uniform load)

E: Longitudinal elastic coefficient of gravure roll

I: Second moment of area of gravure roll

L: Face length of gravure roll (distance between bearings)/2

x: Distance from the central point of the axial length of gravure roll

Then, the doctor blade 3 is bent as substantially much as the gravure roll 1 is according to the equation (4). In this arrangement, from the beginning of the initial stage of the incorporation of the doctor blade 3, the contact end 3a of the doctor blade 3 is allowed to come in contact with the surface of the gravure roll 1 which has been bend by its own weight uniformly along the axial length thereof. Accordingly, the spread of the coating solution over the surface of the gravure roll 1 is uniform along the axial length of the roll, making it possible to control the spread of the coating solution to a predetermined value precisely so that the coating solution can be uniformly spread on the film base 4 along the crosswise direction. In this arrangement, necessity of conducting running-in operation from the beginning of the initial stage of the incorporation of the doctor blade 3 can be eliminated, making it possible to enhance the productivity.

The aforementioned gravure coating apparatus 100 can exert a remarkable effect of uniformizing the distribution of spread of coating solution particularly when the diameter of the gravure roll 1 is not smaller than 15 mm. For example, in the case where the diameter of the gravure roll 1 falls below 15 mm, when the doctor blade 3 is pressed against the gravure roll 1, the gravure roll is bent so much as to become eccentric, possibly causing a periodic unevenness of coating due to the rotation of the gravure roll 1. Accordingly, the effect of uniformizing the spread of coating solution in the crosswise direction of the film base (axial direction of the gravure roll) can be effectively exerted particularly when the diameter of the gravure roll 1 is not smaller than 15 nm.

A second embodiment of the apparatus for coating a thin film according to the invention will be described hereinafter.

FIG. 12 is a diagram illustrating the essential part of a gravure coating apparatus of direct gravure coating type according to the second embodiment of implementation of the invention.

While the apparatus 100 for coating a thin film (gravure coating apparatus) of the aforementioned first embodiment of the invention is an example of the coating apparatus of reverse gravure coating (kiss) type in which the gravure roll 1 rotates in the direction opposite the conveyance direction of the film base 4, the apparatus for coating a thin film of the present embodiment is a gravure coating apparatus of direct gravure coating type (direct).

The invention can apply also to such a direct gravure coating system. In accordance with the constitution of direct gravure coating, a backup roll 14 is disposed in parallel to and nipped on the gravure roll (transferring member) 1 with the film base 4 interposed therebetween. In operation, the gravure roll 1 and the backup roll 14 are rotated in the forward direction with respect to the conveyance direction of the film base 4. The nip pressure across the backup roll 14 and the gravure roll 1 is adjusted with a cylinder 16 which presses against the backup roll shaft. In the following various embodiments, where the parts function in the same way as those of FIG. 1, the same numbers are used and the description of those parts will be omitted.

In this embodiment, too, the provision of the air inflow preventive cover 65 causes the occurrence of a flow of an inert gas from the interior to the exterior of the isolated space S isolated from the open air that blows off the surface air layer 7 entrained by the film base 4 which is being conveyed. Accordingly, only the film base 4 free of surface air layer 7 is conveyed into the isolated space S inside the air inflow preventive cover 65. In this manner, the inflow of the surface air layer 7 containing much water content can be prevented, making it possible to prevent the rise of relative humidity in the isolated space S.

In the gravure coating apparatus 100 and 200 of the aforementioned first and second embodiments, the mesh of the gravure roll 1 maybe in any form such as diagonal line (diagonal cup), lattice (trapezoidal cup) and pyramid (pyramid-shaped cup).

The gravure roll 1 is essentially formed by a metal but may be a ceramic gravure roll comprising a metallic roll coated with an abrasion-proofing ceramic coat on which a mesh is formed.

As the material of the doctor blade 3 there may be used any of metal such as SK material (carbon tool steel according to JIS G 4401) and Swedish steel and resin such as polypropylene. The doctor blade 3 formed by a metal can exhibit a sufficient abrasion resistance as well as a high rigidity and hence a good capability of scraping off the excess coating solution, making it sure that the distribution of spread of coating solution is precise and stable. On the other hand, the doctor blade 3 formed by a resin cannot scratch the gravure roll.

The doctor blade 3 preferably comes in contact with the gravure roll 1 in such an arrangement that the tangent line of the gravure roll 1 at the point of contact with the doctor blade 3 crosses the doctor blade 3 at an angle of not greater than 45°. In this arrangement, good scraping properties can be obtained.

A third embodiment of the apparatus for coating a thin film according to the invention will be described hereinafter.

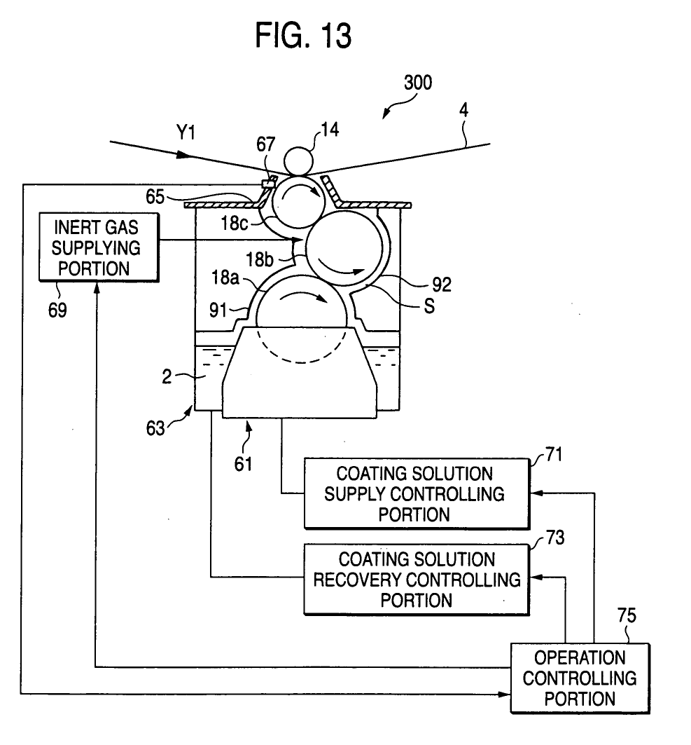

FIG. 13 is a diagram illustrating the essential part of a roll coating type coating apparatus according to the third embodiment of implementation of the invention.

The roll coating type coating apparatus 300 according to the present embodiment comprises transferring rolls (transferring members) in a multi-stage configuration. In this arrangement, the coating solution is transferred from a coating solution supplying portion 61 to a first transferring roll 18a. The transferring solution is then transferred from the first transferring roll 18a to a second transferring roll 18b. The coating solution is further transferred from the second transferring roll 18b to a third transferring roll 18c. The film base 4.1s conveyed through the nip between the third transferring roll 18c and a backup roll 14 disposed opposed thereto. In the interior of the coating solution recovering portion 63, inner covers 91 and 92 are provided along the outer surface of the transferring rolls 18a, 18b and 18c to inhibit the evaporation of the solvent from the vapor-liquid interface on the various rolls.

In this case, too, the provision of the air inflow preventive cover 65 causes the occurrence of a flow of an inert gas from the interior to the exterior of the isolated space S isolated from the open air that blows off the surface air layer 7 entrained by the film base 4 which is being conveyed as described above. Accordingly, only the film base 4 free of surface air layer 7 is conveyed into the isolated space S inside the air inflow preventive cover 65.

A fourth embodiment of the apparatus for coating a thin film according to the invention will be described hereinafter.

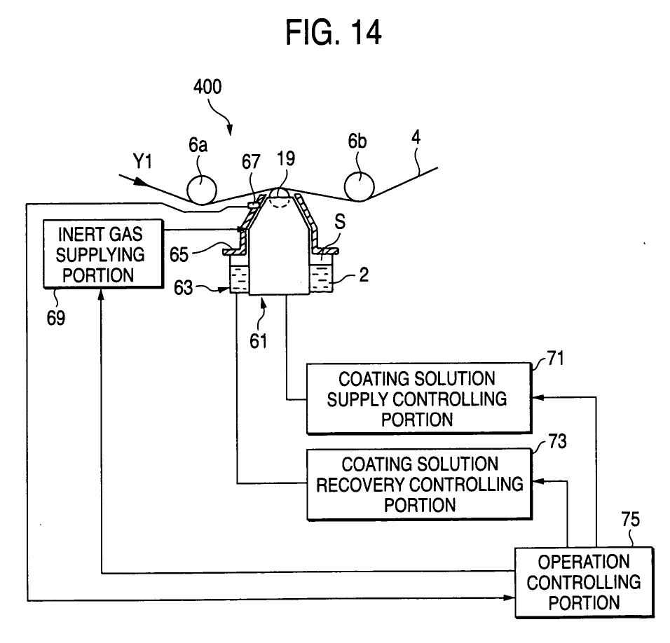

FIG. 14 is a diagram illustrating the essential part of a bar coating type coating apparatus according to the fourth embodiment of implementation of the invention.

The bar coating type coating apparatus 400 of the present embodiment uses a roll (transferring member) 19 having a diameter as small as from about 3 mm to 30 mm to supply the coating solution onto the film base 4. The surface of the roll 19 has a roughness formed by winding a wire material round the roll almost all over the crosswise direction (axial direction) to help supply the coating solution.

In this case, too, the provision of the air inflow preventive cover 65 causes the occurrence of a flow of an inert gas from the interior to the exterior of the isolated space S isolated from the open air that blows off the surface air layer 7 entrained by the film base 4 which is being conveyed as described above. Accordingly, only the film base 4 free of surface air layer 7 is conveyed into the isolated space S inside the air inflow preventive cover 65.

While the aforementioned various apparatus for coating a thin film have been described with reference to the arrangement that there is provided a sensor 67 for detecting any of nitrogen concentration, relative humidity, evaporation of coating solution, etc. in the space defined by the air inflow preventive cover 65 and the coating solution supply controlling portion 71 or the coating solution recovery controlling portion 73 is feedback-controlled according to the output of the sensor 67, the invention is not limited thereto. The space may be merely defined by the cover 65.

The various modifications of the air inflow preventive cover shown in the first embodiment may be applied to the other embodiments to exert similar effects.

The film base 4 used in the various embodiments may be sheet-like or may be a belt-like continuous film or paper base. The film base to be used preferably has a width of 3 m at maximum and a thickness of from 5 μm to 300 μm, but the invention is not limited thereto.

As the film base 4, a proper material may be selected depending on the purpose. In practice, a transparent support is used. As the transparent support there is preferably used a plastic film. Examples of the polymer forming the plastic film include cellulose esters (e.g., triacetyl cellulose, diacetyl cellulose), polyamides, polycarbonates, polyesters (e.g., polyethylene terephthalate, polyethylene naphthalate), polystyrenes, and polyolefins.

The coating solution is not specifically limited. In practice, however, those having a solid content concentration of from 0.01 to 50% by weight, a viscosity of from 0.1 to 30 cP and a spread of not greater than 30 cc/m² can easily exert the effect of the invention. Further, the coating solution may be aqueous or organic solvent-based. As the aqueous binder there may used any material such as gelatin and PVA which can be dissolved in water and then dried to form a film. As the solvent-based binder there may be used a monomer or polymer. Examples of the monomer include monomers having two or more ethylenically unsaturated groups, esters of polyvalent alcohol with (meth)acrylic acid (e.g., ethylene glycol di(meth)acrylate, 1,4-cyclohexanediacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra (meth) acrylate, dipentaerythritol penta (meth) acrylate, dipentaerythritol hexa(meth)acrylate, 1,2,3-cyclohexanetetramethacrylate, polyurethane polyacrylate, polyester polyacrylate), vinylbenzenes, derivatives thereof (e.g., 1,4-divinylbenzene, 4-vinylbenzoic acid-2-acryloylethylester, 1,4-divinylcyclohexanone), vinylsulfones (e.g., divinylsulfone), acrylamides (e.g., methylene bisacrylamide), and methacrylamide.

Crosslinkable groups may be incorporated instead of or in addition to the monomer having two or more ethylenically unsaturated groups. Examples of the crosslinkable functional group include isocyanate group, epoxy group, aziridine group, oxazoline group, aldehyde group, carbonyl group, hydrazine group, carboxyl group, methylol group, and active methylene group. There may be vinyl sulfonic acid, acid anhydride, cyano acrylate derivative, melamine, etherified methylol, ester, urethane, metal alkoxide such as tetramethoxysilane, and block isocyanate group. In the case where the coating solution comprises such a compound having a crosslinkable group, it is necessary that the coating solution which has been spread be subjected to crosslinking by heating or other means. Other examples of the crosslinkable functional group include bis(4-methacryloylthiophenyl)sulfide, vinyl naphthalene, vinyl phenyl sulfide, and 4-methacryloxyphenyl-4′-methoxyphenylthioether.

The coating solution may further comprise the following inorganic particulate material incorporated therein.

In some detail, an ultrafinely particulate material of oxide of titanium, aluminum, indium, zinc, tin, antimony or zirconium having a particle diameter of not greater than 100 nm, preferably not greater than 50 nm, is used. Examples of such an ultrafinely particulate material include TiO₂, Al₂O₃, In₂O₃, ZnO, SnO₂, Sb₂O₃, ITO, and ZrO₂.

The content of the aforementioned particulate material in the binder is preferably from 10% to 90% by weight, more preferably from 20% to 80% by weight based on the total weight of the coating solution.

Other examples of the binder include crosslinkable fluorine-based polymers such as perfluoroalkyl group-containing silane compound (e.g., (heptadecafluoro-1,1,2,2-tetradecyl) triethoxysilane), and fluorine-containing copolymers comprising a fluorine-containing monomer component and a monomer component for providing a crosslinkable group as constituents.

Specific examples of the aforementioned fluorine-containing monomer component include fluoroolefines (e.g., fluoroethylene, vinylidene fluoride, tetrafluoroethylene, hexafluoroethylene, hexafluoropropylene, perfluoro-2,2-dimethyl-1,3-dioxol), partially or fully-fluorinated alkylester derivatives of (meth)acrylic acid (e.g., Biscoat 6FM (produced by OSAKA ORGANIC CHEMICAL INDUSTRY LTD.), M-2020 (produced by DAIKIN INDUSTRIES, LTD.)), and fully or partially-fluorinated vinylethers.

Examples of the monomer component for providing a crosslinkable group include (meth) acrylate monomers having a crosslinkable functional group in its molecule such as glycidyl methacrylate, and (meth)acrylate monomers having carboxyl group, hydroxyl group, amino group, sulfonate group, etc. (e.g., (meth)acrylic acid, methylol (meth)acrylate, hydroxyalkyl (meth) acrylate, allyl acrylate). It is known in JP-A-10-25388 and JP-A-10-147739 that the latter compounds allow the incorporation of a crosslinked structure after copolymerization.

Besides the aforementioned polymer comprising a fluorine-containing monomer as a constituent unit, a copolymer with a monomer free of fluorine atom may be used.

The monomer to be used additionally is not specifically limited. Examples of such a monomer include olefins (e.g., ethylene, propylene, isoprene, vinyl chloride, vinylidene chloride), acrylic acid esters (e.g., methyl acrylate, ethyl acrylate, 2-ethylhexyl acrylate), methacrylic acid esters (e.g., methyl methacrylate, ethyl methacrylate, butyl methacrylate, ethylene glycol dimethacrylate), styrene derivatives (e.g., styrene, divinylbenzene, vinyltoluene, α-methylstyrene), vinylethers (e.g., methyl vinyl ether), vinylesters (e.g., vinyl acetate, vinyl propionate, vinyl cinnamate), acrylamides (e.g., N-tert-butylacryamide, N-cyclohexylacrylamide), methacrylamides, and acrylonitrile derivatives.

As the solvent there may be used mainly an alcohol or ketone. Examples of the alcohol employable herein include methanol, ethanol, propanol, isopropanol, and butanol. Examples of the ketone employable herein include methyl ethyl ketone, methyl isobutyl ketone, and cyclohexanone. Besides these solvents, toluene or acetone maybe used. These solvents may be used singly or in admixture.

### EXAMPLE

The coating solutions set forth in Table 1 are each examined for increase of viscosity and water content after 5 hours of elapse of time after spread using gravure coating apparatus comprising various air inflow preventive covers.

The coating solutions initially had a water content of 0.1%, a viscosity of about 1 cP and a temperature of 25° C. The ambient atmosphere had a temperature of 25° C. and a relative humidity of 60%. It is known that the coating solution shows the same tendency when the ambient air has a temperature of from 15° C. to 30° C. and a humidity of from 35% to 80%. As the coating solution there is used a coating solution of acrylic resin in methyl ethyl ketone (MEK) or MEK and cyclohexanone in admixture.

The results are set forth in Table 1.

TABLE 1

| | | | Distance | | | |
|---|---|---|---|---|---|---|
| | | | between cover | | | |
| | | | and | | | |
| | | Area of | vapor-liquid | Surface air | Increase of | |
| | | clearance | interface | layer | viscosity | % Increase of |
| Example No. | Solvent | [m²/m] | [mm] | shielded ? | after 5 hours | water content |
| Example 1 | MEK | 0.40 | 10 | Yes | None | 0.05 |
| Example 2 | MEK | 0.35 | 5 | Yes | None | 0.03 |
| Example 3 | MEK + | 0.30 | 8 | Yes | None | 0.02 |
| | cyclohexanone | | | | | |
| Comparative | MEK | 0.40 | approx. 20 | Yes | 0.3 cP | 0.40 |
| Example 1 | | | | | | |
| Comparative | MEK | 0.35 | 10 | No | 0.5 cP | 0.35 |
| Example 2 | | | | | | |
| Comparative | MEK + | 0.60 | 8 | Yes | 0.4 cP | 0.38 |
| Example 3 | cyclohexanone | | | | | |

As can be seen in Table 1, Comparative Example 1, in which the distance between the air inflow preventive cover and the vapor-liquid interface is about 20 mm, showed a rise of viscosity of the coating solution and an increased rise of water content of the coating solution after 5 hours even if the surface air layer is shielded. Comparative Example 2 showed a rise of viscosity of the coating solution and an increased rise of water content of the coating solution when the surface air layer is unshielded even if the distance between the air inflow preventive cover and the vapor-liquid interface is 10 ma. Further, Comparative Example 3, in which the area of clearance is 0.6 m²/m, showed a rise of viscosity of the coating solution and an increased rise of water content of the coating solution even if the distance between the air inflow preventive cover and the vapor-liquid interface is reduced and the surface air layer is shielded.

On the contrary, Examples 1, 2 and 3 of the invention, in which the area of clearance is not greater than 0.4 m²/m, the distance between the air inflow preventive cover and the vapor-liquid interface is not greater than 10 mm and the surface air layer is shielded, showed no increase of viscosity of the coating solution and an extremely small rise of water content after 5 hours.

As mentioned above, in accordance with the method and apparatus for coating a thin film, the vapor-liquid interface is covered by an air inflow preventive cover on the area except the area of contact of the transferring member with the film, causing the vapor-liquid interface which doesn't need to be exposed to the open air to be isolated from the open air and hence forming an isolated space between the air inflow preventive cover and the surface of the transferring member. In this arrangement, the inflow of the open air directly into the isolated space can be prevented. Further, the evaporation of the solvent for the coating solution in the vicinity of the vapor-liquid interface such as surface of the transferring member can be inhibited, preventing the drop of the temperature of the coating solution and hence the dew condensation of water content in the air. Moreover, by extending the edge of the opening of the air inflow preventive cover to a position in the vicinity of the film base, the introduction of a surface air layer entrained by the film base into the isolated space during the conveyance of the film base can be prevented. This effect of preventing the inflow of open air and the dew condensation of water content can prevent the water content from being taken in the coating solution. As a result, the occurrence of defects such as streak in the spread state of the coating solution on the film base can be prevented, making it possible to stabilize the application of the coating solution to the film base and uniformize the amount of the coating solution spread on the entire surface of the film base.

What is claimed is:

1. A method for coating a thin film comprising the steps of:
supplying an organic solvent-based coating solution onto the surface of a transferring member,
allowing the coating solution to come in contact with a film base to be applied thereto,
partially recovering the coating solution supplied onto the transferring member for reuse,
wherein
the vapor-liquid interface is covered by an air inflow preventive cover on the area except the area of contact of the transferring member with the film base, while the contact area is exposed at the opening,
the edge of the opening of the air inflow preventive cover extends to a position in the vicinity of the film base at least on the film base conveyance side, and
the coating zone of the transferring member is disposed in a isolated space formed by partitioning from the open air.

2. The method for coating a thin film as in claim 1, further comprising a step of;
supplying an inter gas into the interior of the isolated space.

3. The method for coating a thin film as in claim 1, further comprising a step of:
sucking to remove a surface air layer entrained by the film base which is being conveyed on the film base conveyance side.

4. An apparatus for coating a thin film which supplies an organic solvent-based coating solution onto the surface of a transferring member from which the coating solution is allowed to come in contact with a film base so that the coating solution is applied thereto while the coating solution supplied onto the transferring member is being partially recovered for reuse,
said apparatus comprising:
a coating solution recovering portion, and
an air inflow preventive Cover including an opening at which the area of contact of the transferring member with the film base is exposed, and covering the vapor-liquid interface on the area except the contact area,
the edge of the opening extending to a position in the vicinity of the film base.

5. The apparatus for coating a thin film as in claim 4, wherein
the air inflow preventive cover has a wall portion extending along the external surface of the transferring member, and
the opening is formed at the forward end of the external wall portion.

6. The apparatus for coating a thin film as in claims 4, wherein
the area of the clearance between the air inflow preventive cover and the surface of the transferring member is not greater than 0.4 m²n/m per unit length thereof, and
the clearance between the edge of the air inflow preventive cover and the film base is not greater than 10 mm.

7. The apparatus for coating a thin film as in claim 4, further comprising:
an inert gas supplying portion for supplying an inert gas into the interior of the isolated space.

8. The apparatus for coating a thin film as in claim 4, further comprising:
a suction duct for sucking a surface air layer entrained by the film base which is being conveyed at the film base conveyance side.
